(19) United States
(12) Patent Application Publication
(10) Pub. No.: US 2024/0237589 A1
(43) Pub. Date: Jul. 18, 2024

(54) HIGH-DENSITY GROW RACK SYSTEM WITH INTEGRATED TRACK CONVEYANCE AND POST-PROCESSING AND CONTROLS

(71) Applicant: Cheng LI, Burnaby (CA)

(72) Inventor: Cheng LI, Burnaby (CA)

(21) Appl. No.: 18/562,745

(22) PCT Filed: May 12, 2022
(86) PCT No.: PCT/CN2022/092334

§ 371 Date: Nov. 20, 2023

(30) Foreign Application Priority Data
May 21, 2021 (CN) 202110557740.5

(51) Int. Cl. A01G 9/029; A01G 7/04; A01G 9/00; A01G 31/02

(52) U.S. Cl. CPC A01G 9/0297; A01G 7/045; A01G 31/02; A01G 2009/003

(57) ABSTRACT

By providing a high-density grow rack system, mechanized through the use of tracks and trays for conveyance, non-productive space in vertical farms is minimized, and optimization for space in vertical farms is achieved. Advantages of the system include: flexibility and integration, allowing adaptability to various vertical farming layouts and seamless transition between growing and processing phases; modular processing units for assembly-line-style crop processing, enhancing operational efficiency; interconnected crop trays on tracks, eliminating non-productive gaps and significantly improving space utilization; adjustable layer heights catering to different crop growth stages; and independent climate control with insulating boards between units, reducing energy consumption and waste. Overall, this system significantly advances vertical farming efficiency and productivity.

### BACKGROUND

### Technical Field

The present disclosure pertains to the field of agricultural technologies, specifically focusing on vertical farming systems. It introduces a high-density grow rack system equipped with a track-based conveyance mechanism for automation. Additionally, the system features post-processing and control modules.

### Description of the Related Art

Traditional agricultural productivity is heavily dependent on favorable weather conditions and is adversely affected by unfavorable environmental factors. To mitigate these dependencies, greenhouse farming emerged, utilizing techniques such as artificial lighting to supplement sunlight deficiencies or temperature control systems to moderate the effects of seasonal variations.

However, with the advancement of technology, vertical farming has emerged as an innovative solution to address the inefficiencies inherent in traditional agriculture. This approach is particularly suited to urban settings, where it reduces transportation and distribution challenges and contributes to environmental sustainability. The aim of vertical farming is to transform the agricultural industry by industrializing the production of high-quality agricultural products in a cost-effective manner.

Vertical farms can offer several advantages:
1. Independence from soil constraints. Vertical farming eliminates the issue of continuous cropping as it pertains to traditional agriculture.
2. Climate resilience. Crops grown in enclosed spaces are protected from the elements.
3. Efficient water usage. Advanced irrigation technology used in vertical farming can save up to 95% of needed water and energy.
4. High potential of automation. Vertical farming reduces the dependence labor has on productivity.
5. Space optimization. Vertical farming significantly increases land-use efficiency.
6. Time efficiency. Vertical farming shortens crop growth cycles and enables multi-season cultivation.

Organic crops grown in vertical farms are typically robust, high-quality, and free from pollution, pesticides, or fertilizers. A computer-controlled, soilless, and sterile planting environment can allow for consistent quality regardless of geography, enable automated operations, and ensure crop quality while eliminating human contamination.

Vertical farms, despite their advantages, face significant challenges. High initial investment, coupled with low automation levels, results in substantial labor costs and operational expenses. These factors contribute to increased product prices, which in turn limit consumer access and hinder scalability. A central aspect of vertical farming is the cultivation of crops in stacked layers. This structure traditionally relies on elevators for management, leading to operational complexities, inefficiencies, and potential safety hazards. To overcome these limitations, some farms have adopted robotic automation. However, the substantial investment in robotics, along with ongoing maintenance costs and considerable energy consumption, presents additional challenges. Some objectives for improving vertical farming systems, therefore, are reducing operational costs and enhancing overall efficiency.

In vertical farming, reducing operational costs is often achieved by increasing the yield per unit volume, akin to enhancing yield per acre in traditional farming. This approach centers on maximizing crop production within a limited spatial footprint, thereby enhancing productivity, reducing per-unit costs, and accelerating the recovery of investments. However, a challenge emerges when planting more crops: it necessitates an increase in grow racks, leading to the requirement of larger areas. Traditional vertical farm designs exacerbate this issue by requiring intervals of unused space between racks for maintenance and additional space for post-processing activities. As the number of racks increases, so does this effectively non-productive space, consequently reducing the area available for actual crop cultivation and thus impacting overall efficiency.

The challenge with the interval space between grow racks is that it cannot be significantly reduced using existing methods, as it is necessary for various processing activities. Typically, processing occurs in an area frontal to the grow racks, but eliminating this space would require moving these activities to the sides. However, side processing is limited, only reaching the edges of one or two planting spaces.

### BRIEF SUMMARY

Embodiments of the present invention provide a high-density grow rack system, automated with a track-based conveyance system and equipped with integrated post-processing and control modules. This design effectively addresses space utilization issues by allowing for efficient use of the entire area dedicated to crop cultivation.

By providing a high-density grow rack system, mechanized through the use of tracks and trays for conveyance, non-productive space in vertical farms is minimized, and optimization for space in vertical farms is achieved.

Embodiments of the present invention may be characterized by one or more of the following components:
1. Grow rack structure: A high-density grow rack structure comprised of a plurality of grow rack units, seamlessly arranged in an array. Each grow rack unit comprises or consists of multiple vertically stacked grow layers, each layer having varied inter-layer spacing within the same unit.
2. Conveyance system: Each grow layer is equipped with its own dedicated track system. Crop trays, designed to hold crops, are positioned on the tracks. The crop trays are interconnected using adjustable connecting components, allowing for versatile arrangement and movement. A pulley system facilitates the precise positioning and movement of the crop trays.
3. Transfer platforms: Positioned on one or either side of each grow rack unit are transfer platforms. The platforms can move between grow layers and grow rack units, and are outfitted with tracks that are designed to interface seamlessly with the tracks on the grow layers and post-processing platform, facilitating efficient movement and transfer of the trays.
4. Modularized post-processing platform: On the periphery of the grow rack structure is a post-processing platform. This platform includes a transport track that interfaces with both the grow rack unit tracks and the mobile transfer platform tracks. The transport track is equipped with, at a minimum, functional processing modules for tasks such as harvesting, cleaning, and transplanting arranged in sequence.

Embodiments of the present invention offer flexibility and convenience. The track and tray system is designed to be adaptable to any three-dimensional farming platform, making it suitable for a wide variety of vertical farm layouts. Moreover, embodiments of the invention seamlessly integrate between the processes of growing and processing, effectively resolving the issues of low efficiency and high labor costs.

The crop trays are introduced onto the grow layer tracks via a pulley system, while the tracks on the grow rack unit are maintained in a fixed position. Once positioned, the crop trays remain stationary on the layer tracks. For the purposes of adjusting the growth environment or harvesting the crops, the platform tracks on the transfer platform are aligned with the grow layer tracks. This alignment facilitates the efficient movement of the crop trays from the grow rack unit onto the platform tracks. As the tracks used are pliable and the post-processing units modular and adaptable in configuration, the system can be customized for different vertical farm layouts.

A feature of this system is the interconnected nature of the crop trays on each layer. With this design, only a single connection needs to be established for each grow rack unit, effectively eliminating gaps between units and substantially enhancing space utilization. This approach enables the system to potentially expand a farm's capacity by 50 to 90%, representing a significant improvement in operational efficiency and productivity for vertical farming operations.

A common limitation in conventional vertical farms is the fixed distance between vertically stacked grow layers. This rigidity poses a challenge as different crops have varying height requirements throughout their growth cycles. Additionally, the intensity of light from grow lamps diminishes significantly with increasing distance from the light source. For instance, increasing the distance from a horizontally moving light source from 15 to 30 inches results in a 61.4% decrease in light density. In comparison, a fixed light source under the same conditions shows a 78.1% decrease, leading to suboptimal photosynthesis, slower growth rates, prolonged plant cycles, and ultimately reduced profit margins. To address this issue, vertical farms often resort to installing additional or higher-powered grow lamps, which can be inefficient and costly. However, the proposed high-density grow rack system offers a solution by allowing the heights between grow layers to be variable. This flexibility enables the system to provide optimal lighting conditions for a variety of crops at different stages of their growth, effectively utilizing fixed light sources. As a result, this feature can lead to enhanced crop growth and development, reducing the need for excessive lighting infrastructure and thereby lowering investment and operational costs.

The use of crop trays allows for swift and effortless movement of crops between the grow rack units and the transfer platform, completing transfers within minutes. Crop trays can be transferred to layers of varying heights, maintaining continuous and stable development. This feature increases design versatility, enabling the lighting infrastructure to be finely tuned to the specific needs of various crops at different stages of their growth cycles.

The grow rack unit of embodiments of the present invention is designed using a frame structure, wherein adjacent grow rack units are integrated into a single, complete frame. The grow rack units are subdivided by this framework into adjacent rectangular sub-units, each housing multiple crop trays. These sub-units are systematically organized in a grid-like pattern, defined by a row and column format, with each sub-unit being uniquely numbered.

The frame structure enhances the convenience of assembly, significantly reducing installation hardware costs and streamlining the installation of tracks and other components. The dense arrangement of the grow rack units, facilitated by the shared frames, enables an increase in crop density while concurrently reducing overall costs. The unique numbering of each sub-unit, corresponding to rows and columns, provides a systematic approach for automated control systems. This facilitates quick and precise positioning of the transfer platform for accessing specific sub-units, effectively creating spatial coordinate points within the grow rack system.

The grow layer tracks comprise or consist of pairs of parallel rails. These rails are mounted within the frame structure of the grow rack units, the transfer platform, and the post-processing platform. The mounting is achieved using a plurality of brackets. Each grow layer track has terminating ends, designed to function as junctions. These junctions can interface and connect with other tracks within the system, thereby facilitating loading and unloading processes.

The system incorporates multiple track types. Each type is comprised of a pair of rails to enhance stability. The design of the terminating ends is interchangeable, allowing for easy interfacing between different track types.

According to some embodiments, the grow rack units use linear tracks. The transfer platform uses linear, curved, and spiral tracks. The post-processing platform includes the following variations: a flat, linear-type platform; a flat “U”-style platform; a vertical “S”-style platform; and a “L”-style platform.

The diversity of track styles and layouts imbues the system with high flexibility, facilitating the interfacing of tracks between different rows and columns, as well as between various post-processing activities. This design enables efficient movement of crop trays to diverse positions within the system. Such an arrangement maximizes the utilization of space, aids in the precise adjustment of crop growth positions, and efficiently manages post-harvest activities including cleaning, transplanting, and other sequential processes.

The transport platform is mounted on either the frame of the high-density planting rack, or a roof structure above it through vertical and/or horizontal moving arms. That is, moving arms capable of moving vertically, horizontally, and up and down are set up on the periphery of the planting rack. Through the movement of these moving arms, the transfer platform is driven to move forward, backward, left, right, and up and down, so as to dock with the grow layer tracks of different layers.

The crop trays are outfitted with mounting plates at both ends. These plates host the necessary hardware to connect each end of the tray to the pulley system used for conveyance. On the upper surface of these trays, holes are placed at regular intervals, used for planting crops and securely anchoring them to the tray. Within each layer of the grow rack units, multiple such trays are positioned, spaced at regular, adjustable intervals. This adjustability is achieved through the use of adjustable connecting components between the trays, offering flexibility in arrangement based on the crop requirements. Furthermore, each tray is assigned a unique serial number.

The pulley system comprises a primary connecting shaft that is attached to the crop tray. Said shaft is integrated with an upper connecting plate which is equipped with a pair of upper U-grooved wheels that engage the top of the rail. Attached to the side wall of the upper connecting plate are a plurality of secondary connecting shafts. Said shafts connect to a lower connecting plate, which includes a pair of lower U-grooved wheels. The wheels on the lower connecting plate engage with the bottom of the rail. Furthermore, said secondary connecting shafts are outfitted with side wheels that engage the side of the rail. The combination of wheels ensures stable and accurate operation of the conveyance system. Said upper wheels and lower wheels straddle the rail, while said side wheels support said tray laterally, ensuring that said crop tray does not derail during operation.

Each grow rack sub-unit is equipped with its own lighting apparatus, while adjacent units are separated by insulating boards, which are installed on the frame structure.

By eliminating non-productive space between grow rack units, the installation of insulating boards on each grow rack unit becomes feasible. This design allows for the climate within each unit to be independently and precisely controlled, tailored to meet the specific growth requirements of a variety of plants. Such customization significantly increases the growth rate per unit by providing optimal environmental conditions for each type of plant. Furthermore, focusing climate control specifically on the grow units themselves, rather than the entire facility, substantially reduces the need for overarching climate control. This targeted approach minimizes the energy required to maintain the desired climate in areas that are not directly involved in plant growth, thereby reducing operational costs.

Embodiments of the present invention include a post-processing system which includes a post-processing platform which contains modules for activities such as seeding, packaging, and other processing tasks.

Embodiments of the present invention include a control system which includes a plurality of processing modules and a central controller that oversees and directs said modules. Said control system executes instructions for the following operational states, including but not limited to:
State (1): When harvesting is required, the control system directs the transfer platform to dock with the appropriate grow layer tracks in a grow rack unit. This process can also be manually controlled.
State (2): Crop trays are transferred from said grow rack unit to said transfer platform.
State (3): Said transfer platform is maneuvered to dock with the transport tracks on post-processing platform.
State (4): Said crop trays are transferred to said post-processing platform for processing.
State (5): Following the completion of post-processing tasks on said post-processing platform, said crop trays are returned to said transfer platform.
State (6): Said transfer platform relocates to the original position on said grow rack unit, returning said crop trays to their respective positions on said grow rack unit.

The control system also controls irrigation, lighting, and climate. It automatically adjusts for the optimal growth environment for different crops and their needs at different points in their growth cycles. When crops need to be moved between different grow rack units, the system executes instructions for the following operational states, including but not limited to:
State (1): When the crops in a grow rack unit reach their upper limit of growth, the control system directs the transfer platform to dock with the appropriate grow layer tracks in said grow rack unit. This process can also be manually controlled.
State (2): Crop trays are transferred from said grow rack unit to the transfer platform.
State (3): Said transfer platform is maneuvered to dock with the target grow rack unit.
State (4): Said crop trays are transferred from the transfer platform to the tracks on the target grow rack unit.

Through the use of modular processing units, embodiments of the invention achieve flexible assembly-line-style processing in the later stages of planting. This reduces the operational complexity facing conventional vertical farm systems and increases processing efficiency.

Compared to existing technology, advantages of embodiments of the current invention may be as follows:
1. Flexibility and Integration: The utilization of tracks and trays adds flexibility and convenience, making the system adaptable to any vertical farming layout. This design achieves seamless integration between growing and processing phases, addressing the challenges of low processing efficiency and high labor costs in vertical farms.
2. Modular Processing Units: The introduction of modular processing units allows for assembly-line-style processing in the latter stages of crop growth. This innovation reduces operational complexity compared to traditional vertical farm systems and enhances processing efficiency. The tracks are designed to be bendable and pliable, allowing for a variety of configurations of the modular units. This versatility accommodates different farm layouts, providing flexibility in the arrangement of the high-density grow rack structure.
3. Interconnected Crop Trays and Space Utilization: The use of interconnected crop trays on each layer, placed on tracks, simplifies operations. With the need for accessibility from only one side of a grow rack unit, non-productive gaps between units are eliminated. This significantly improves space utilization, potentially expanding farm capacity by 50 to 90% with the use of this system.
4. Adjustable Layer Heights: The system's adjustable layer heights facilitate the accommodation of different crops at various growth stages, optimizing the efficiency of grow light systems.
5. Independent Climate Control with Insulating Boards: The incorporation of insulating boards between grow rack units enables independent climate control for each unit. This targeted climate control approach, focusing on grow units rather than the entire facility, markedly reduces energy consumption and waste, leading to further cost savings.

### BRIEF DESCRIPTION OF THE SEVERAL VIEWS OF THE DRAWINGS

Various other objects, features and attendant advantages of embodiments of the present invention will become fully appreciated as the same becomes better understood when considered in conjunction with the accompanying drawings, in which like reference characters designate the same or similar parts throughout the several views.

FIG. 1 is an upper perspective view of a high-density grow rack system.

FIG. 2 is an enlarged partial view of the high-density grow rack system.

FIG. 3 is an enlarged partial view of the high-density grow rack system.

FIG. 4 is an enlarged partial view of the high-density grow rack system.

FIG. 5 is an upper perspective view of a single grow rack unit.

FIG. 6 is a diagram of how grow racks are numbered.

FIG. 7 is a magnified perspective view of the rail tracks of the grow rack unit.

FIG. 8 is a magnified perspective view of crop trays on a grow rack unit.

FIG. 9 is a magnified perspective view of a wheel system on a crop tray.

FIG. 10 is a magnified perspective view of a linear-type transfer platform.

FIG. 11 is a magnified perspective view of a curved-type transfer platform.

FIG. 12 is a magnified perspective view of a spiral-type transfer platform.

FIG. 13 is a magnified perspective view of a post-processing platform with a flat “U”-style track.

FIG. 14 is a magnified perspective view of a post-processing platform with a vertical “S”-style track.

FIG. 15 is an upper perspective view of two rows of grow racks units as seen in comparative analysis 1.

FIG. 16 is an upper perspective view of three rows of the high-density grow rack system.

FIG. 17 is an upper perspective view of ten rows of grow racks units as seen in comparative analysis 2.

FIG. 18 is an upper perspective view of nineteen rows of the high-density grow rack system.

### DETAILED DESCRIPTION

The technical scheme of embodiments of the invention will be clearly and completely described below in combination with the drawings. It is clear that the described embodiments are only some of the embodiments of the present invention but not all of them. Based on the described embodiments of the invention, all other embodiments obtained by ordinary technicians in the field without creative working conditions fall within the scope of the protection.

In the description, it should be noted that the azimuth or position relations indicated by the terms “middle”, “upper”, “lower”, “inner”, and “outer” are based on the azimuth or position relationship shown in the attached drawings. They are only for the purpose of describing embodiments of the present invention and simplifying the descriptions, rather than indicating or implying that the device or element referred to must have a specific orientation and be constructed and operated in a specific orientation. Therefore, it cannot be understood as a limitation to the present invention. In addition, the terms “first” and “second” are used only for descriptive purposes and cannot be understood to indicate or imply relative importance.

### Embodiment 1

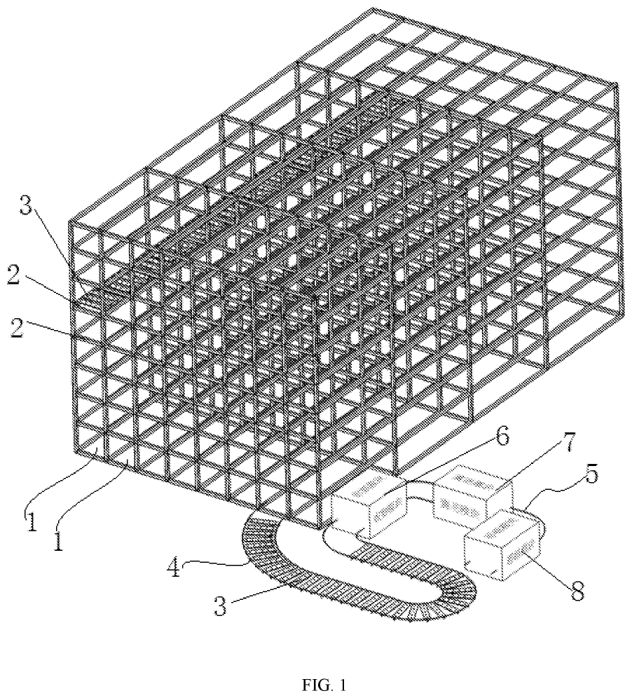

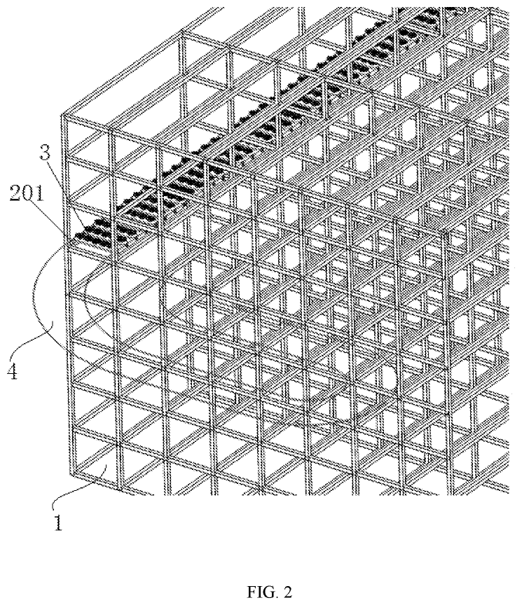

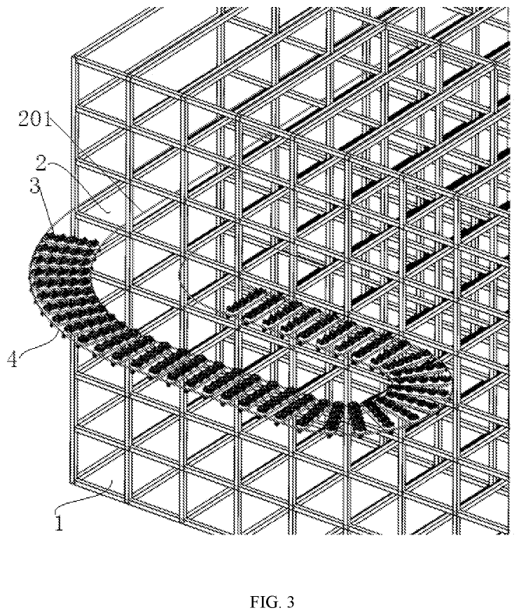

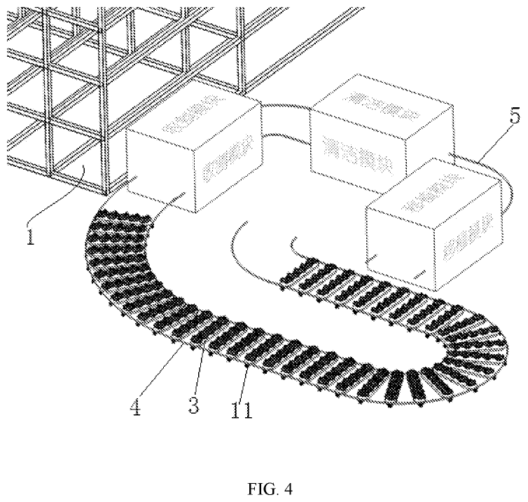

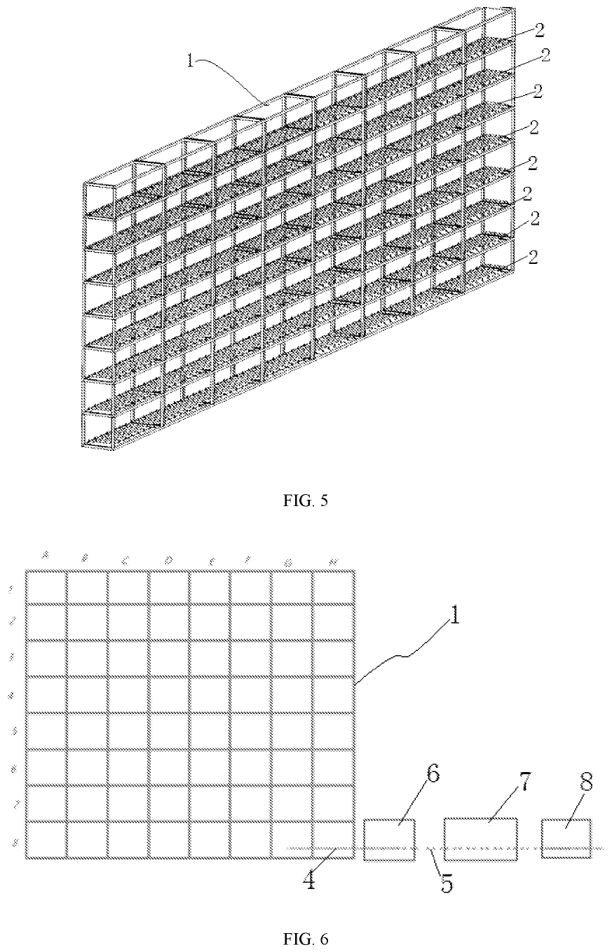

FIGS. 1 through 5 illustrate a high-density grow rack structure, comprised of a plurality of grow rack units 1, seamlessly arranged in an array. Each grow rack unit 1 consists of a plurality of vertically stacked grow layers 2, wherein the height between each layer in grow rack unit 1 varies. Each grow layer 2 is equipped with grow layer tracks 201, configured to support crop trays 3 set via a pulley system 11. Adjacent to each side of said grow rack unit 1, transfer platforms 4 are positioned, each featuring platform tracks designed to interface with said grow layer tracks 201. The high-density grow rack structure further includes a post-processing platform 5 located on the periphery of the grow rack unit 1. Said post-processing platform 5 comprises a transport track that facilitates connection with either said grow layer tracks 201 or the platform tracks. Notably, the post-processing platform 5 is equipped with functional processing modules, which include, but are not limited to, a harvest module 6, a cleaning module 7, and a transplanting module 8.

Embodiments of the present invention offer flexibility and convenience. The track and tray system is designed to be adaptable to any three-dimensional farming platform, making it suitable for a wide variety of vertical farm layouts. Moreover, embodiments of the invention seamlessly integrate between the processes of growing and processing, effectively resolving issues of low efficiency and high labor costs.

The crop trays 3 are introduced onto the grow layer tracks 201 via a pulley system 11, while the tracks on the grow rack unit 1 are maintained in a fixed position. Once positioned, said crop trays 3 remain stationary on the grow layer tracks 201. For the purposes of adjusting the growth environment or harvesting the crops, the platform tracks on the transfer platform 4 are aligned with said grow layer tracks 201. This alignment facilitates the efficient movement of said crop trays 3 from said grow rack unit 1 onto the platform tracks. The tracks are designed to be bendable and pliable, allowing for a variety of configurations of the modular units. This versatility accommodates different farm layouts, providing flexibility in the arrangement of the high-density grow rack structure.

A feature of this system is the interconnected nature of the crop trays 3 on each grow layer 2. With this design, only a single connection needs to be established for each grow rack unit 1, effectively eliminating gaps between units and substantially enhancing space utilization. This approach enables the system to potentially expand a farm's capacity by 50 to 90%, representing a significant improvement in operational efficiency and productivity for vertical farming operations.

A common limitation in conventional vertical farms is the fixed distance between vertically stacked grow layers. This rigidity poses a challenge as different crops have varying height requirements throughout their growth cycles. Additionally, the intensity of light from grow lamps diminishes significantly with increasing distance from the light source. For instance, increasing the distance from a horizontally moving light source from 15 to 30 inches results in a 61.4% decrease in light density. In comparison, a fixed light source under the same conditions shows a 78.1% decrease, leading to suboptimal photosynthesis, slower growth rates, prolonged plant cycles, and ultimately reduced profit margins. To address this issue, vertical farms often resort to installing additional or higher-powered grow lamps, which can be inefficient and costly. However, the proposed high-density grow rack system offers a solution by allowing the heights between grow layers to be variable. This flexibility enables the system to provide optimal lighting conditions for a variety of crops at different stages of their growth, effectively utilizing fixed light sources. As a result, this feature can lead to enhanced crop growth and development, reducing the need for excessive lighting infrastructure and thereby lowering investment and operational costs.

The use of crop trays 3 allows for swift and effortless movement of crops between the grow rack units 1 and the transfer platform 4, completing transfers within minutes. Said crop trays 3 can be transferred to layers 2 of varying heights, maintaining continuous and stable development. This feature increases design versatility, enabling the lighting infrastructure to be finely tuned to the specific needs of various crops at different stages of their growth cycles.

The grow rack unit 1 of embodiments of the present invention is designed using a frame structure, wherein adjacent grow rack units are integrated into a single, complete frame. Said grow rack units 1 are subdivided by this framework into adjacent rectangular sub-units, each housing multiple crop trays 3. These sub-units are systematically organized in a grid-like pattern, defined by a row and column format, with each sub-unit being uniquely numbered, as shown in FIG. 6.

The frame structure enhances the convenience of assembly, significantly reducing installation hardware costs and streamlining the installation of tracks and other components. The dense arrangement of the grow rack units, facilitated by the shared frames, enables an increase in crop density while concurrently reducing overall costs. The unique numbering of each sub-unit, corresponding to rows and columns, provides a systematic approach for automated control systems. This facilitates quick and precise positioning of the transfer platform for accessing specific sub-units, effectively creating spatial coordinate points within the grow rack system.

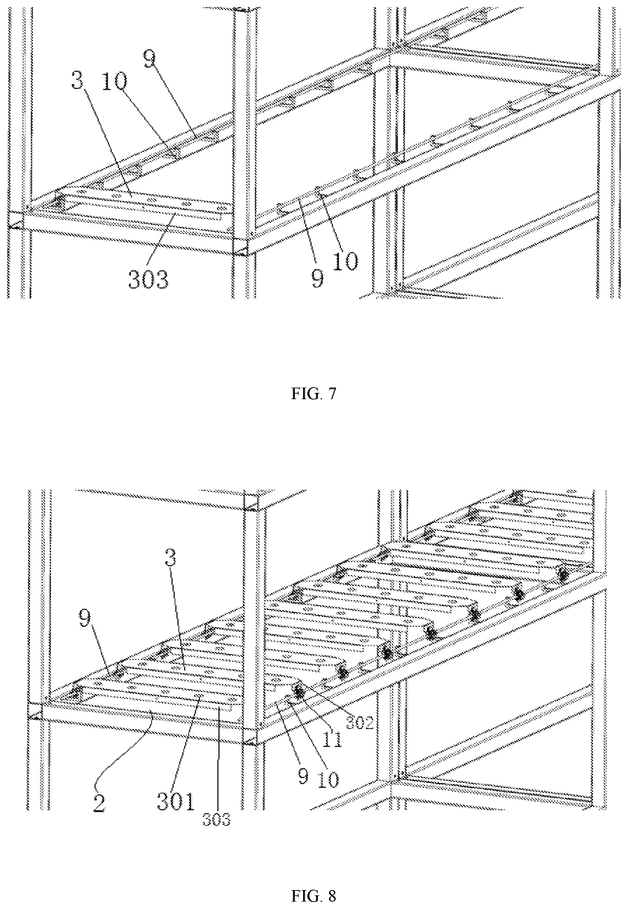

FIG. 7 illustrates a section of grow layer tracks 201, which comprise or consist of a pair of parallel rails 9. Said rails 9 are mounted within the frame structure of the grow rack units 1, the transfer platform 4, and the post-processing platform 5. The mounting is achieved using a plurality of brackets 10. Each grow layer track 201 has terminating ends, designed to function as junctions. These junctions can interface and connect with other tracks within the system, thereby facilitating loading and unloading processes.

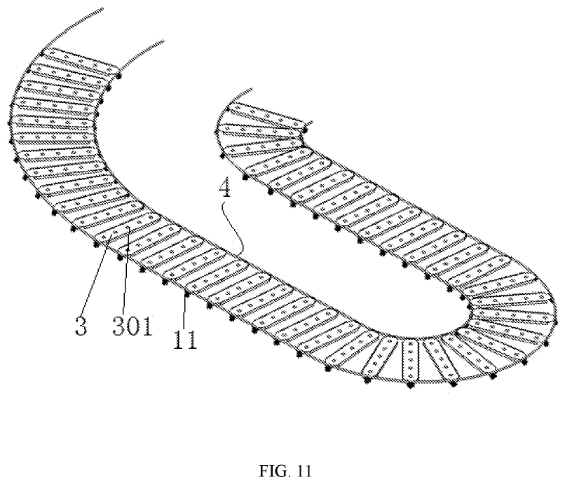

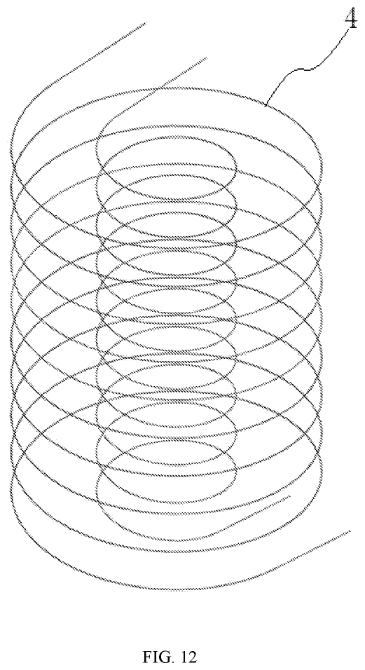

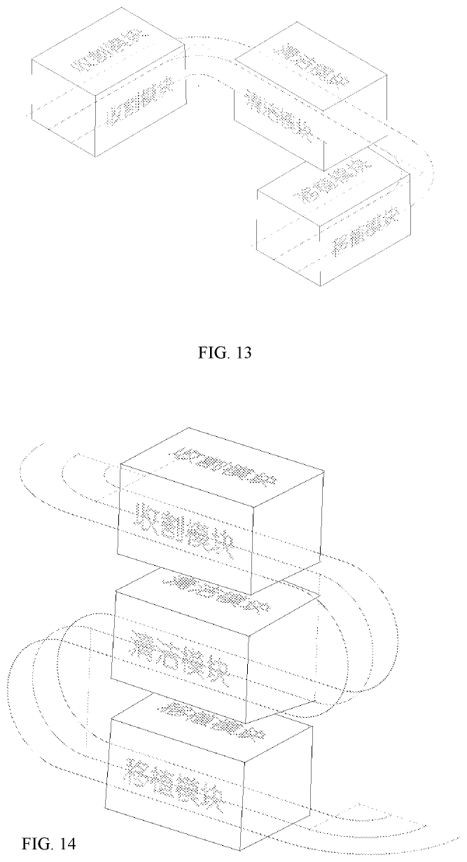

The system incorporates multiple track types. Each type is comprised of a pair of rails to enhance stability. The design of the terminating ends is interchangeable, allowing for easy interfacing between different track types. The grow rack units 201 use linear tracks. The transfer platform 4 uses linear (as shown in FIG. 10), curved (as shown in FIG. 11), and spiral tracks (as shown in FIG. 12). The post-processing platform 5 includes the following variations: a flat, linear-type track; a flat “U”-style track (as shown in FIG. 13); a vertical “S”-style track (as shown in FIG. 14); and a vertical “L”-style track.

The diversity of track styles and layouts imbues the system with high flexibility, facilitating the interfacing of tracks between different rows and columns, as well as between various post-processing activities. This design enables efficient movement of crop trays to diverse positions within the system. Such an arrangement maximizes the utilization of space, aids in the precise adjustment of crop growth positions, and efficiently manages post-harvest activities including cleaning, transplanting, and other sequential processes.

The transport platform 4 is mounted on the frame of the high-density planting rack through vertical and/or horizontal moving arms. That is, moving arms capable of moving vertically, horizontally, and up and down are set up on the periphery of the planting rack. Through the movement of these moving arms, the transfer platform 4 is driven to move forward, backward, left, right, and up and down, so as to dock with the grow layer tracks 201 of different layers 2.

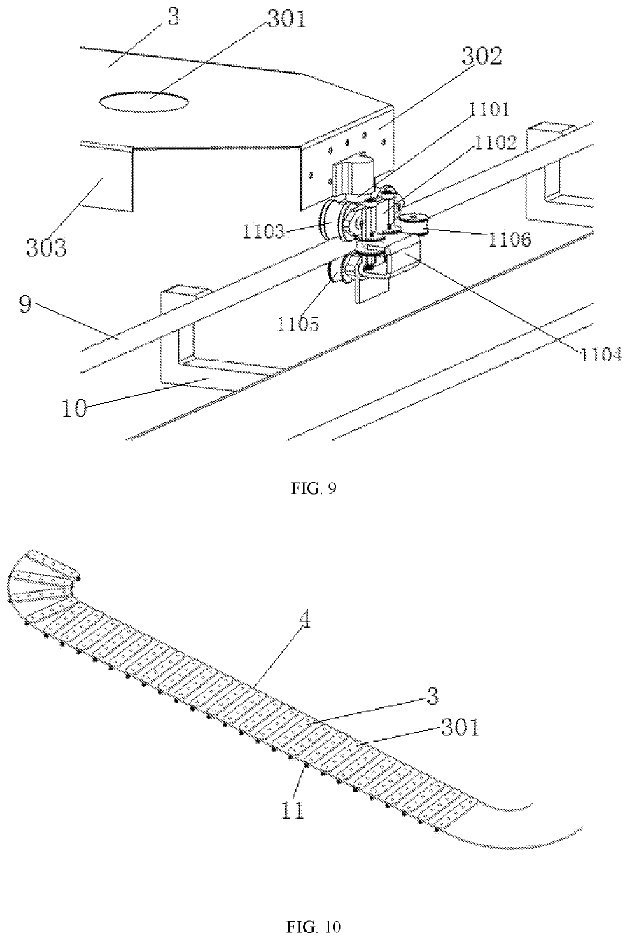

FIGS. 8 and 9 illustrate a crop tray 3 with end-mounting plates 302 that connect said crop tray 3 to the pulley system 11. On the upper surface of said crop trays 3, holes 301 are placed at regular intervals, used for planting crops and securely anchoring them to the tray. Within each layer 2 of a grow rack unit 1, a plurality of crop trays 3 are positioned, spaced at regular, adjustable intervals. Said crop tray 3 also has side-mounting plates 303 that have mounting holes, which can accommodate the installation of connectors. These connectors include adjustable tie rods, springs, connecting hooks, etc. This facilitates the connection of adjacent planting trays 3 and the adjustment and control of the spacing between them.

The pulley system 11 comprises a primary connecting shaft 1101 that is attached to the crop tray 3. Said shaft is integrated with an upper connecting plate 1102 which is equipped with a pair of U-grooved upper wheels 1103 that engage the top of the rail 9. Attached to the side wall of said upper connecting plate 1102 are a plurality of secondary connecting shafts. Said shafts connect to a lower connecting plate 1104, which includes a pair of U-grooved lower wheels 1105. Said wheels 1105 on the lower connecting plate 1104 engage with the bottom of the rail 9. Furthermore, said secondary connecting shafts are outfitted with side wheels 1106 that engage the side of said rail 9. The combination of wheels ensures stable and accurate operation of the conveyance system. Said upper wheels 1103 and lower wheels 1105 straddle said rail 9, while said side wheels 1106 support the tray laterally, ensuring that said crop tray 3 does not derail during operation.

Each grow rack sub-unit (as part of grow rack unit 1) is equipped with its own lighting system, while adjacent units are separated by insulating boards, which are installed on the frame structure.

By eliminating non-productive space between grow rack units 1, the installation of insulating boards on each grow rack unit 1 becomes feasible. This design allows for the climate within each unit 1 to be independently and precisely controlled, tailored to meet the specific growth requirements of a variety of plants. Such customization significantly increases the growth rate per unit by providing optimal environmental conditions for each type of plant. Furthermore, focusing climate control specifically on the grow units themselves, rather than the entire facility, substantially reduces the need for overarching climate control. This targeted approach minimizes the energy required to maintain the desired climate in areas that are not directly involved in plant growth, thereby reducing operational costs.

Embodiments of the present invention include a post-processing system which includes a post-processing platform 5 which contains modules for activities such as seeding, packaging, and other processing tasks.

Embodiments of the present invention include a control system which includes a plurality of processing modules and a central controller that oversees and directs said modules. Said control system may execute instructions for the following operational states, including but not limited to:
State (1): When harvesting is required, the control system directs the transfer platform 4 to dock with the appropriate grow layer tracks 201 in said grow rack unit 1. This process can also be manually controlled.
State (2): Crop trays 3 are transferred from said grow rack unit 1 to said transfer platform 4.
State (3): Said transfer platform 4 is maneuvered to dock with the transport tracks on post-processing platform 5.
State (4): Said crop trays 3 are transferred to said post-processing platform 5 for processing.
State (5): Following the completion of post-processing tasks on said post-processing platform 5, said crop trays 3 are returned to said transfer platform 4.
State (6): Said transfer platform 4 relocates to the original position on said grow rack unit 1, returning said crop trays 3 to their respective positions on said grow rack unit 1.

The control system may also control irrigation, lighting, and climate. It can automatically adjust for the optimal growth environment for different crops and their needs at different points in their growth cycles. When crops need to be moved between different grow rack units, the system may execute instructions for the following operational states, including but not limited to:
State (1): When the crops in a grow rack unit 1 reach their upper limit of growth, the control system directs the transfer platform 4 to dock with the appropriate grow layer tracks 201 in said grow rack unit 1. This process can also be manually controlled.
State (2): Crop trays 3 are transferred from said grow rack unit 1 to the transfer platform 4.
State (3): Said transfer platform 4 is maneuvered to dock with the target grow rack unit.
State (4): Said crop trays 3 are transferred from the transfer platform 4 to the tracks on the target grow rack unit.

### Comparative Analysis 1:

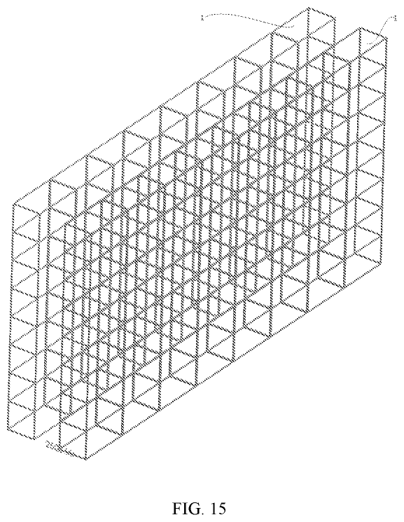

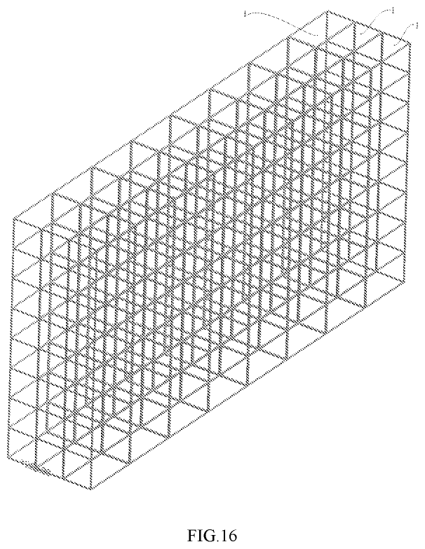

FIG. 15 showcases a hypothetical small-scale vertical farm, featuring two rows of grow rack units. Each of these units measures 1250 mm in width and is separated by a spacing of 1250 mm. Subsequently, FIG. 16 illustrates the implementation of aspects of embodiments of the present invention in the same farm setup. Through the application of aspects of embodiments of the current invention, the 1250 mm spacing between the grow rack units can be effectively eliminated. This results in the accommodation of an additional grow rack unit within the same spatial footprint, thereby enabling an increase in productivity by 50%.

### Comparative Analysis 2:

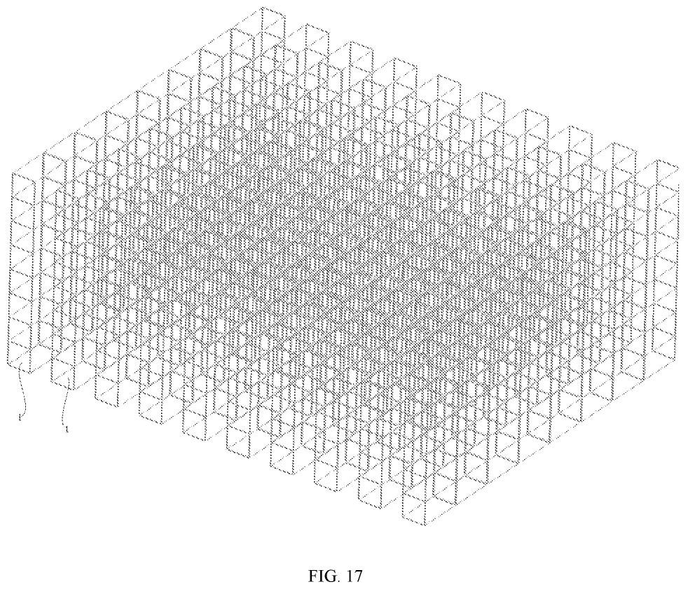

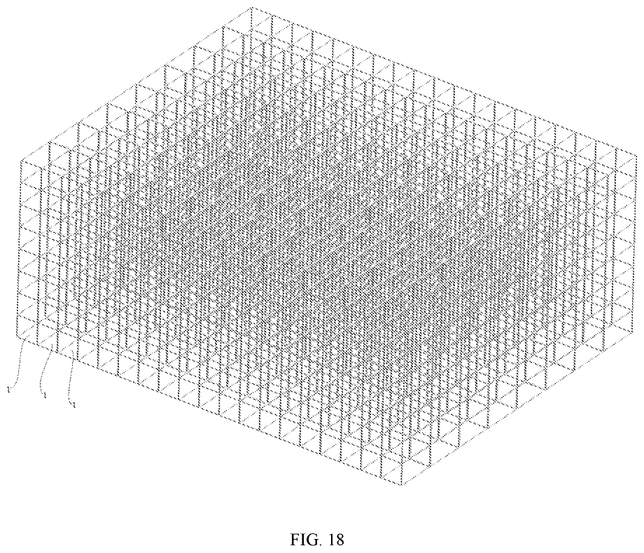

FIG. 17 showcases a hypothetical large-scale vertical farm, featuring ten rows of grow rack units. FIG. 18 then presents the same farm configuration, albeit with the incorporation of aspects of embodiments of the current invention. This results in the accommodation of nine additional grow rack units within the same spatial footprint, thereby enabling an increase in productivity by 90%.

In summary, the use of aspects of the embodiments of the invention described herein markedly improves grow density in vertical farms, with larger farms reaping larger benefits.

Although embodiments of the invention have been shown and described, for ordinary technical personnel in the art, it is understandable that a variety of changes, modifications, replacements, and variants can be made to these embodiments. For example, aspects of the various embodiments described herein can be combined to provide further embodiments.

In general, in the following claims, the terms used should not be construed to limit the claims to the specific embodiments disclosed in the specification and the claims, but should be construed to include all possible embodiments along with the full scope of equivalents to which such claims are entitled.

1. A high-density grow rack system with integrated track conveyance and post-processing and controls, the high-density grow rack system comprising:
a plurality of grow rack units arranged in an array, each grow rack unit including multiple grow layers with inter-layer spacing;
a frame structure for constructing said grow rack units, wherein adjacent grow rack units are integrated into a single frame, and wherein the frame subdivides each grow rack unit into sequentially numbered rectangular sub-units, each sub-unit containing a plurality of evenly spaced crop trays;
an insulating board installed between adjacent grow rack units on the frame structure;
a grow layer track system on each grow layer, configured to support the crop trays via a pulley system;
the pulley system comprising upper, lower, and side wheels engaging tracks of the grow layer track system;
the crop trays comprising end-mounting plates for attachment to the pulley system;
adjustable connecting components on the crop trays;
a transfer platform on each side of the grow rack unit, equipped with a set of tracks for docking with the tracks of the grow layer track system;
the tracks of the transfer platform comprising linear, curved, and/or spiral configurations; and
a post-processing platform located on the periphery of the grow rack unit, including a transport track for connection with either the tracks of the grow layer track system or the tracks of the transfer platform, and equipped with sequential functional processing modules including a harvest module, a cleaning module, and a transplanting module.

2. The high-density grow rack system of claim 1, wherein:
the tracks of the grow layer track system, the tracks of the transfer platform, and the transport track each comprise pairs of parallel rails;
the rails are mounted within the frame structure, the transfer platform, or the post-processing platform using a plurality of brackets; and
the tracks feature terminating ends designed as junctions, which are capable of interfacing and connecting with other tracks within the system.

3. The high-density grow rack system of claim 1, wherein:
the tracks of the grow layer track system utilize linear-style tracks; and
the track of the post-processing platform includes variations comprising one or more of a flat, linear-type track; a flat “U”-style track; a vertical “S”-style track; and a vertical “L”-style track.

4. The high-density grow rack system of claim 1, wherein:
the transport platform is mounted on either the frame structure, or a roof structure above said frame structure using vertical and/or horizontal moving arms.

5. The high-density grow rack system of claim 1, wherein:
the crop trays have a plurality of holes placed at regular intervals, used for planting crops and securely anchoring the crops to the tray; and
each of the crop trays includes adjustable connecting components.

6. The high-density grow rack system of claim 1, wherein:
the pulley system comprises:
a primary connecting shaft attached to the crop tray, integrated with an upper connecting plate;
the upper connecting plate equipped with a pair of U-grooved upper wheels that engage a top of a rail of the tracks;
a plurality of secondary connecting shafts attached to a side wall of the upper connecting plate;
the secondary connecting shafts connecting to a lower connecting plate, which includes a pair of U-grooved lower wheels that engage a bottom of the rail of the tracks; and
the secondary connecting shafts also outfitted with a side wheel that engages a side of the rail of the tracks.

7. The high-density grow rack system of claim 1, wherein:
each rectangular sub-unit includes a respective lighting system.

8. The high-density grow rack system of claim 1, wherein:
the system includes a post-processing system featuring a post-processing platform which contains modules for activities including at least one of seeding and packaging.

9. The high-density grow system of claim 1, wherein:
the system includes a control system comprising a plurality of processing modules and a central controller that oversees and directs the processing modules, the control system configured to execute instructions to perform one or more of the following:
when harvesting is required, the control system directs the transfer platform to dock with appropriate tracks of the grow layer track system in a grow rack unit;
transfer crop trays from said grow rack unit to said transfer platform;
maneuver the transfer platform to dock with the transport track of the post-processing platform;
transfer the crop trays to said post-processing platform for processing;
following completion of post-processing tasks on said post-processing platform, return said crop trays to said transfer platform; and
relocate the transfer platform to an original position on said grow rack unit, thereby returning said crop trays to respective positions on said grow rack unit.
